(19) United States
(12) Patent Application Publication
(10) Pub. No.: US 2006/0049341 A1
(43) Pub. Date: Mar. 9, 2006

(54) Method for examining corrosion of a steel reinforcement rod embedded in concrete

(75) Inventors: Chung-Yue Wang, Taipei (TW); Peng-Ching Peng, Zhonghe City (TW)

Correspondence Address: TROXELL LAW OFFICE PLLC;SUITE 1404, 5205 LEESBURG PIKE, FALLS CHURCH, VA, 22041, US

(73) Assignee: National Central University, Kawasaki (JP)

(21) Appl. No.: 10/995,360

(22) Filed: Nov. 24, 2004

(30) Foreign Application Priority Data
Sep. 6, 2004 (JP) 2004-258772

(51) Int. Cl. G01J 1/04

(52) U.S. Cl. 250/227.14

(57) ABSTRACT

The present invention is a method for examining corrosion on a reinforcement steel. A sensor with a fiber Bragg grating is connected with a coupler; and the coupler is connected with a laser and an analyzer. Apply the sensor at a proper position on the reinforcement steel. A light source of the laser goes to the sensor through the coupler; and then the light passes the sensor and is transferred back to the analyzer. The analyzer can then figure out the strain out of the deformation and swell on the reinforcement steel owing to its corrosion by detecting the drift of the Bragg wavelength of the light. By doing so, the present invention obtains high sensitivity, strong corrosion sustainability and electromagnetic jam prevention so that the accuracy of the detection becomes higher and it can be widely applied to examine the corrosion on the reinforcement steel in a long term.

### FIELD OF THE INVENTION

The present invention relates to a method for examining a reinforcement steel; more particularly, relates to a method for examining the trend of the corrosion of a reinforcement steel with high sensitivity, strong corrosion sustainability and electromagnetic jam prevention under a long-term monitoring.

### DESCRIPTION OF THE RELATED ARTS

Nowadays, common methods for examining the corrosion of a reinforcement steel embedded in a concrete are potential detection, DC linear polarization and AC impedance method.

The above three methods are all related to conductivity and potential. Yet, when the chloride ion in the concrete surrounding the reinforcement steel increases or the concrete is in a process of carbonization or the concrete is with porosity, the potential or the resistance detected will be apparently influenced by them. It is because the chloride ion will increase conductivity; the process of carbonization may produce a potential for the interface as high as 200 mV (millivolt); and, following the increase in the porosity, the resistance may be increased. As a result, the above three methods are all apt to be influenced by the potential or the resistance deviated following the change of the concrete.

Moreover, for example, if a potential detection is used (based on ASTM-C876, the most common method used in this kind of business) and the original corrosion potential detected is under −350 mV, the potential detected may become −150 mV under the influence of the process of carbonization so that erroneous judgments may be increased and an on-the-spot examination may become harder. Consequently, the methods according to the prior arts do not fulfill all the requirements on actual use.

### SUMMARY OF THE INVENTION

Therefore, the main purpose of the present invention is to be widely applied to examine the status of the corrosion on a reinforcement steel in a construction in a long term. In addition, the corrosion speed of the reinforcement steel detected can be a base for evaluating the safety of the construction.

Another purpose of the present invention is to obtain high sensibility, strong corrosion sustainability and electromagnetic jam prevention for improving the accuracy of the examination.

The third purpose of the present invention is to find out the strength of a reinforcement steel as a base for figuring out a way to strengthen the construction.

To achieve the above purposes, the present invention is a method for examining corrosion of a steel reinforcement rod embedded in concrete, comprising the following steps:
1. Obtain a sensor having a fiber Bragg grating; connect it with a coupler under a proper protection; and depose it at a proper position on a reinforcement steel.
2. Connect a laser and an analyzer to the coupler, where a light is emitted from the laser to the sensor through the coupler and the light is transferred back to the analyzer after passing through the sensor.
3. At last, by detecting the drift of the Bragg wavelength of the light, the strain out of the deformation and swell on the reinforcement steel owing to corrosion is examined.

By doing so, the present invention obtains high sensibility, strong corrosion sustainability and electromagnetic jam prevention for improving the accuracy of the examination and can be widely applied to examine the status of the corrosion on a reinforcement steel in a long term.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a system view according to the present invention; and

FIG. 2 is a flow cart diagram according to the present invention.

### DESCRIPTION OF THE PREFERRED EMBODIMENT

The following descriptions of the preferred embodiments are provided to understand the features and the structures of the present invention.

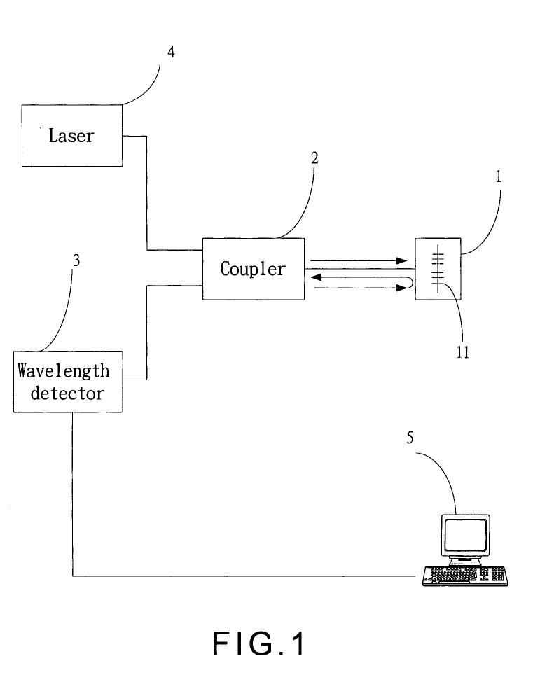

Please refer to FIG. 1, which is a system view according to the present invention. As shown in the figure, the present invention is a system comprising a sensor 1, a coupler 2, a wavelength detector 3, a laser 4 and an analyzer.

A method for examining the corrosion of a reinforcement steel by using the above system comprises the following steps:
i. Obtain a sensor 1 having a fiber Bragg grating 11, which can be a round bushing or a clamper.
ii. Connect a coupler 2 to the sensor 1 under a proper protection, which can be a one-to-two coupler.
iii. Depose the sensor 1 at a proper position on a reinforcement steel.
iv. Connect a laser 4 and an analyzer 5 to the coupler 2, and depose a wavelength detector 3 between the coupler 2 and the analyzer 5 so that, according to the present invention, examination accuracy can be improved with the coordination of the analyzer 5 and the wavelength detector 3, while the laser can be a broadband light source capable of emitting broadband light and the analyzer 5 can be an optical-spectrum analyzer or a power meter.
v. Emit a light from the laser 4 to the sensor 1 through the coupler 2 and the light is transferred back to the analyzer 5 after passing through the sensor 1.
vi. By detecting the drift of the Bragg wavelength of the light, examine the strain out of the deformation and swell on the reinforcement steel owing to corrosion.

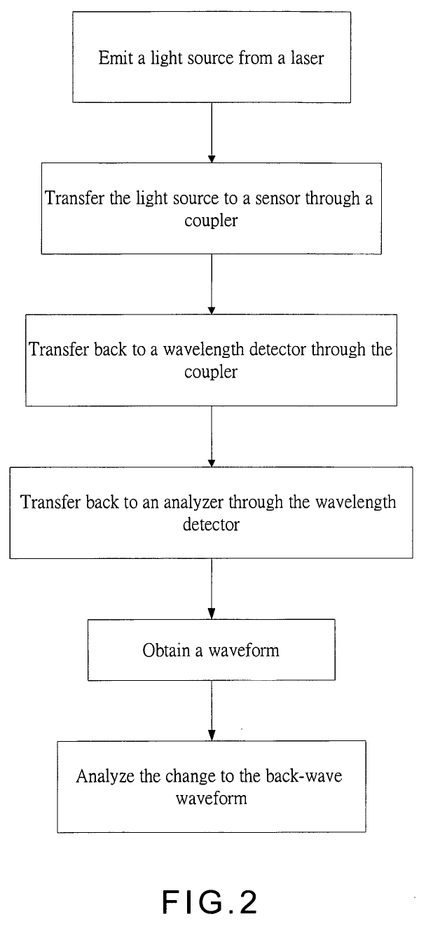

When using, the present invention can be applied to a yet-formed construction by deposing the sensor 1 with a fiber Bragg grating 11 at a proper position on the to-be-examined reinforcement steel, where the shape of the sensor is a round bushing or a clamper. The analyzer can also be set in a control room (such as a generator room, a guardroom, etc.) for long-term monitoring or examining to obtain data as a reference to evaluate the future safety of the construction. When examining (further referring to FIG. 1 and FIG. 2), a broadband light is emitted to the sensor 1 through the coupler 2 out of a broadband source made by the laser 4, where, at the mean time, the broadband light emitted to the sensor 1 made by the laser 4 is transferred back to the analyzer 5 by the wavelength detector between the coupler 2 and the analyzer 5 for obtaining a back-wave waveform by the analyzer 5. While utilizing the relationship between the strain and the drift of the fiber Bragg grating 11 of the light source detected by the analyzer 5, the difference between the optical loss and that of the curvature caused by the corrosion, swell and/or deformation of the reinforcement steel are examined by the sensor 1. Because the fiber Bragg grating 11 on the sensor 1 has its original waveform and the waveform will be changed once the reinforcement steel is corroded, swelled and/or deformed, if no shift is happened to the back-wave waveform as comparing to the original waveform of the fiber Bragg grating 11, it is proved that no corrosion, swell and/or deformation on the reinforcement steel is happened. On the contrary, if shift is happened to the back-wave waveform as comparing to the original waveform of the fiber Bragg grating 11, it is proved that some corrosion, swell and/or deformation on the reinforcement steel is happened. As a result, because the wavelength of the back wave from the sensor 1 is related to its strain, by deposing the fiber Bragg grating 11 on the sensor 1 and detecting the back wave by the analyzer 5, the corrosion, swell and/or deformation of the reinforcement steel can be examined and their trends can be managed in a long term base by keeping monitoring the changes of the back wave.

To sum up, the present invention is a method for examining corrosion of a steel reinforcement rod embedded in a concrete, which overcomes the difficulties and drawbacks on examining corrosion of a reinforcement steel when using the traditional methods.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for examining corrosion of a steel reinforcement rod embedded in concrete, comprising steps of:
a. obtaining a sensor having a fiber Bragg grating to be connected with a coupler under a protection, and deposing said sensor on a reinforcement steel; and
b. connecting a laser and an analyzer to said coupler, emitting a light from a laser to a sensor passing through said coupler, transferring back said light to said analyzer, and, by detecting the drift of the Bragg wavelength of said light, examining the strain out of the deformation and swell on said reinforcement steel owing to corrosion.

2. The method according to claim 1, wherein said sensor is a round bushing.

3. The method according to claim 1, wherein sensor is a clamper.

4. The method according to claim 1, wherein said coupler is a one-to-two coupler.

5. The method according to claim 1, wherein said laser is a broadband light source capable of emitting a broadband light.

6. The method according to claim 1, wherein said analyzer is an optical-spectrum analyzer.

7. The method according to claim 1, wherein said analyzer is a power meter.

8. The method according to claim 1, wherein a wavelength detector is deposed between said coupler and said analyzer.
